(19) United States
(12) Patent Application Publication
(10) Pub. No.: US 2016/0293212 A1
(43) Pub. Date: Oct. 6, 2016

(54) PERFORMING PROCESSING-INTENSIVE OPERATION ON MULTI-TASKING LIMITED-CAPACITY DEVICES

(71) Applicant: Microsoft Technology Licensing, LLC, Redmond, WA (US)

(72) Inventors: Li Li, Redmond, WA (US); Cheng-mean Liu, Redmond, WA (US); Sumit Malhotra, Bellevue, WA (US); Xin Xin, Redmond, WA (US); Kristin Carr, Redmond, WA (US); Yongjun Wu, Bellevue, WA (US); Bryan Tsai, Bellevue, WA (US)

(21) Appl. No.: 14/675,371

(22) Filed: Mar. 31, 2015

(51) Int. Cl. G11B 27/031; G11B 27/10

(52) U.S. Cl. CPC G11B 27/031; G11B 27/102

(57) ABSTRACT

A facility for completing a set of operations is described. Under the control of an application, the facility registers the background task to perform the set of operations. In response to the registration of the background task, the facility repeatedly invokes the background task to perform the set of operations.

### TECHNICAL FIELD

The described technology is directed to the field of background processing techniques.

### BACKGROUND

Video editing refers to generating a video sequence, in some cases a video sequence that includes music or other audio. For example, a user can specify a sequence of still images, graphics surfaces, and/or video clips, audio mixing, visual compositions and transitions between them, accompanying audio resources, and timing aspects about which components start when. Producing a video sequence based upon such input from a user generally involves performing format conversion, video resolution changes, and audio sampling rate changes, from various resource types such as images, audio sequences, and video sequences.

Recently, video editing applications have become available that permit users of smart phones to perform video editing.

### BRIEF DESCRIPTION OF THE DRAWINGS

FIG. 1 is a block diagram showing some of the components typically incorporated in at least some of the computer systems and other devices on which the facility operates.

FIG. 2 is task diagram showing interaction that occurs between several tasks in accordance with the facility in some examples.

FIG. 3 is a flow diagram showing example acts that may be performed by the facility in some examples to register the application's background task and fire a trigger for causing its automatic invocation.

FIG. 4 is a flow diagram showing example acts that may be performed by the facility in some examples to administer the trigger for invocation of the background task.

FIG. 5 is a flow diagram showing example acts that may be performed by the facility in some examples to perform processing-intensive operations in the background task, such as those relating to transcoding and generating a video sequence.

FIG. 6 is a flow diagram showing example acts that may be performed by the facility in some examples to make the operations performed by the background task more interruptible.

FIG. 7 is flow diagram showing steps that may be performed by the facility in some examples to supervise the background task's use of resources.

FIG. 8 is a network diagram showing an environment in which the facility may operate in some examples.

### SUMMARY

A facility for completing a set of operations is described. In one example facility, under the control of an application, the facility registers the background task to perform the set of operations. In response to the receipt registration of the background task, the facility repeatedly invokes the background task to perform the set of operations.

### DETAILED DESCRIPTION

The inventors have recognized that conventional video editing applications for smartphones have significant disadvantages. In particular, after collecting user input specifying how the video sequence should be constructed, these applications tend to do the format conversions and other operations needed to generate the resulting video sequence in the main application thread. These format conversions are typically processor-intensive, especially on a smart phone that has a significantly less-powerful processors than a desktop or laptop computer; as a result, successfully generating a video sequence with such conventional applications usually requires that, after specifying how a video sequence should be constructed, the user permit the application to continue running uninterrupted for a significant period of time—often a minute or more—while it performs the necessary conversions and saves the video sequence. This is a difficult proposition for many smart phone users, who instead tend to switch to one or more other applications, causing the video-editing application to run slowly, be suspended, or even be swapped out of working memory or terminated. When this happens, the video sequence does not end up being generated and saved, and the user is discouraged.

In response to this recognition, the inventors have conceived and reduced to practice a software and/or hardware facility for performing processing intensive operations—such as video-editing and associated format conversion and/or transcoding—on smart phones, tablet computers, wearable computers, and other multi-tasking, limited-capacity devices (“the facility”).

The facility makes use of a mechanism, such as one provided by an operating system, for invoking background tasks for performing processing-intensive operations. In accordance with the facility, an application (1) isolates code for performing the processing-intensive operations, such as video transcoding, and (2) registers a trigger used to automatically invoke this application code for performing the processing-intensive operations in a background task. In some examples, as part of registering the trigger, the application can establish conditions that are to be satisfied in order for the application's processing-intensive code to be invoked. Available conditions include maximum ambient processing loads, minimum amount of time since the last user interaction, a maximum number of background tasks executing for other applications, etc. In some examples, some of these conditions are established automatically by the facility, either as a matter of course, or based upon some analysis of the application's processing-intensive code, the application's importance, etc.

In response to registration of the trigger, until the trigger is disabled, the facility periodically invokes the application's processing-intensive code in the background task, subject to any conditions specified during the trigger's registration.

In some examples, when the background task finishes executing the application's processing-intensive code, the application's main code is notified. For example, for the video-editing application, upon receiving such a notification, it can make the resulting video sequence available for playing by the user, sharing or uploading by the user, etc.

In some examples, when the background task finishes executing the application's processing-intensive code, the trigger is disabled. In various examples, this is done in the background task, or in the application's main code upon notification that the background task has completed.

In some examples, the facility includes a resource manager that observes the use of resources by the background task, and compares them to resource limits established for the background task. For example, in various examples, the facility supports specification of resource limits such as a maximum memory allocation for the background thread, a maximum processing allocation for the background thread, etc. If, while executing, the background task exceeds any of these resource limits, the resource manager kills the background task without disabling its trigger. Accordingly, the facility will later reinvoke the background task based upon the trigger, and the background task continues based on the previous ending point.

In some examples, the processing-intensive code executed in the background task is structured to do its processing in discrete, low-overhead “chunks,” each of whose result is saved persistently as soon as it is completed, to facilitate performing the processing-intensive operations across multiple invocations of the background thread, where the background thread is terminated by the resource manager for over-use of resources, by restarting the device or its operating system, etc. For example, in the case of video-editing, each chunk is the transcoding needed to generate output video for a subsequent span of time, such as 5 seconds, such that the background thread can generate 10 seconds of the result in the first invocation, the next 5 seconds in the second implication, the next 20 seconds in the third implication, etc.

In some examples, rather than or in addition to being established for known inputs like a human-authored video-editing composition, a trigger is established in accordance with the facility to execute the background task against inputs that arise over time, such as to examine the photographs and video clips that that have recently been shot with the phone, automatically author a composition that incorporates them, and perform the necessary transcoding to generate the resulting video sequence. In some such examples, the facility establishes rigorous conditions for invoking the background tasks for these triggers, so that these background tasks are scheduled at times when the risk of them competing for resources is low, such as when the screen is off, or when the user hasn't provided any input for an extended period such as five minutes.

In some examples, the facility offloads the processing of certain processing-intensive operations to a separate device, such as to a cloud server, or to a desktop or laptop computer having extra processing capacity.

By performing in some or all of the ways described above, the facility facilitates the completion of processing-intensive operations on multi-tasking devices—such as those with limited capacity—in a manner that interferes minimally with use of the device for other purposes.

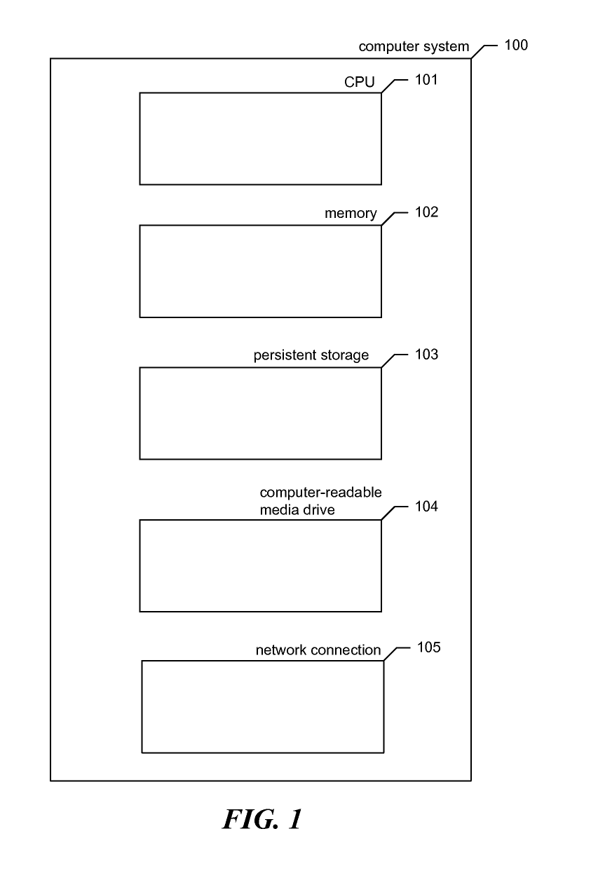

FIG. 1 is a block diagram showing some of the components typically incorporated in at least some of the computer systems and other devices on which the facility operates. In various examples, these computer systems and other devices 100 can include server computer systems, desktop computer systems, laptop computer systems, netbooks, mobile phones, personal digital assistants, televisions, cameras, automobile computers, electronic media players, etc. In various examples, the computer systems and devices include zero or more of each of the following: a central processing unit (“CPU”) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

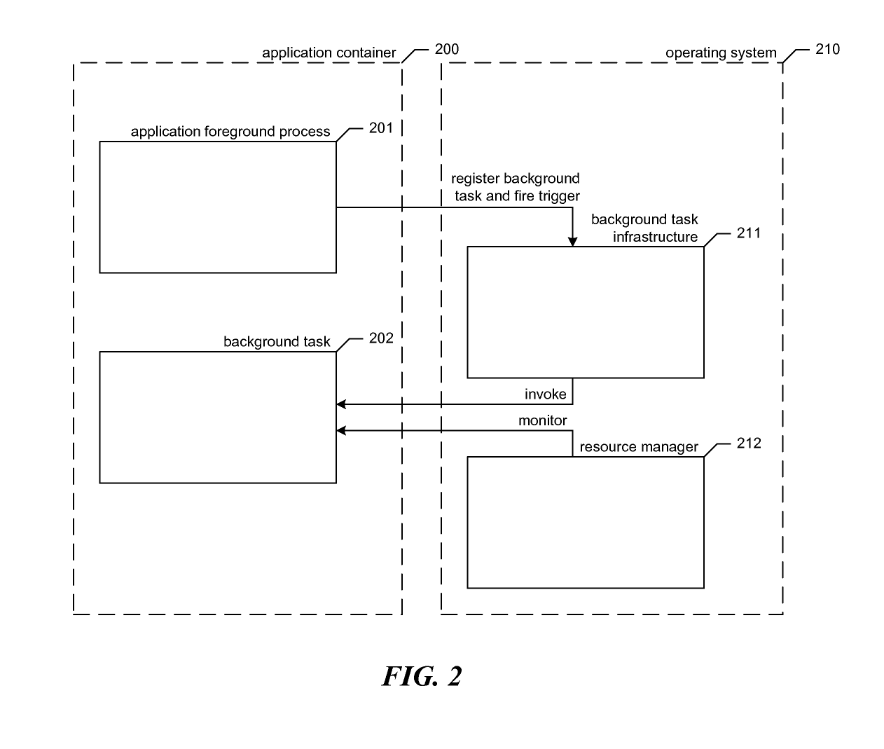

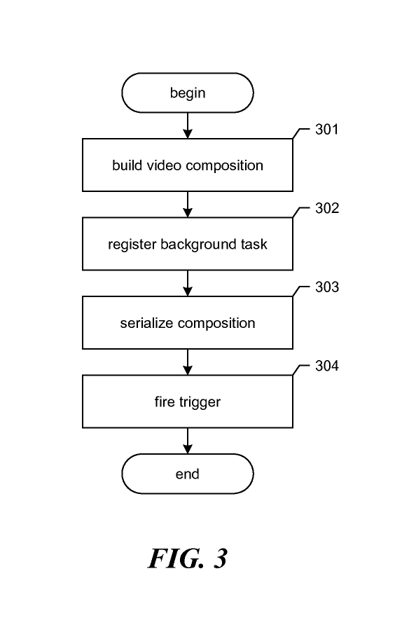

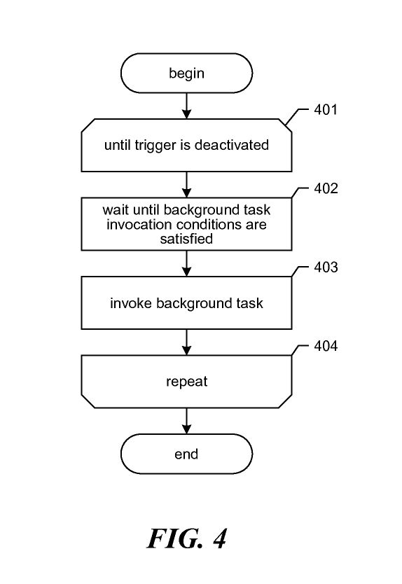

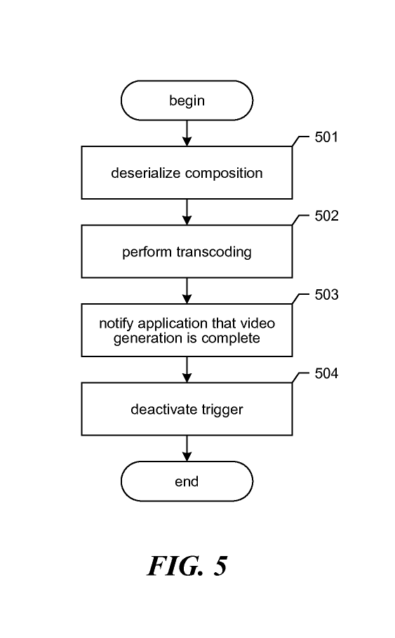

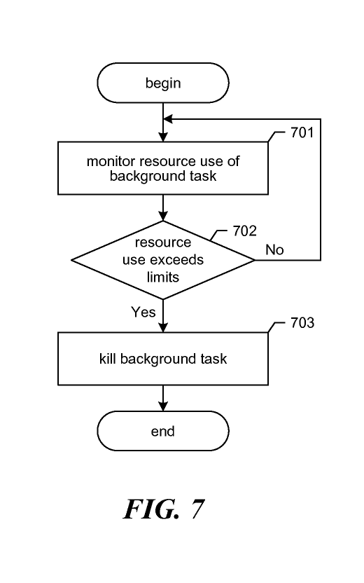

FIG. 2 is task diagram showing interaction that occurs between several tasks in accordance with the facility in some examples. In various examples, these tasks are threads, processes, and/or units of execution of various other kinds. In some examples, both an application foreground process 201 and a background task 202 are provided by the application developer, such as in an application container 200 that persists across different application sessions and can be a basis for sharing data between the application program process and the background task. An operating system 210 running on the device provides a background task infrastructure 211 and a resource manager 212. As is discussed further below in connection with FIG. 3, the application foreground process registers its background task with the background task infrastructure, and fires a trigger responsible for invoking the background task. In response, as is discussed below in more detail with respect to FIG. 4, the background task infrastructure invokes the background task, subject to any invocation conditions. In some examples, the background task infrastructure repeatedly invokes the background task until its trigger is disabled. As is discussed further below in connection with FIG. 5, when the background task completes its processing, it notifies the application of this fact, and deactivates the trigger. In some examples, as is discussed further below in connection with FIG. 7, the resource manager monitors resource usage by the background task, and, in various examples, terminates the background task or otherwise controls its use of resources in response to determining that its use of resources is excessive, such as by determining that it is exceeding explicitly-expressed resource limitations.

FIG. 3 is a flow diagram showing example acts that may be performed by the facility in some examples to register the application's background task and fire a trigger for causing its automatic invocation. In some examples, the facility performs these acts in the application foreground process. At 301, the application builds a video composition, such as in response to user interactions selecting constituent resources corresponding to images, video clips, visual transitions, audio sequences, etc., This video composition specifies an order and timing for combining them in the video sequence to be produced. At 302, the facility registers the background task. Table 1 below shows pseudocode corresponding to one way in which the facility can register the background task, including registering a trigger for the background task.

TABLE 1

| | |
|---|---|
| 1 | trigger = ref new ResourceIntensiveTrigger ( ); |
| 2 | builder = new BackgroundTaskBuilder( ); |
| 3 | builder.name = name; |
| 4 | builder.TaskEntryPoint = taskEntryPoint; |
| 5 | builder.SetTrigger(trigger ); |
| 6 | builder.Register( ); |

In line 1, the facility instantiates a new object of class ResourcelntensiveTrigger called trigger. In line 2, the facility instantiates a new object of the class BackgroundTaskBuilder( ) called builder. In lines 3-6, the facility initializes the builder object. In particular, in line 4, the facility initializes a TaskEntryPoint data member of the builder object within entry point for the application code that will run in the background task. In line 5, the facility invokes a SetTrigger method of the builder object to associate the trigger object with the builder object. Finally, in line 6, the facility invokes a Register method of the builder object to register the background task and its trigger.

At 303, the facility serializes the composition built in step 301; that is, it saves the composition in a manner that makes it accessible to the background task, such as within the application container. At 304, the facility fires a trigger associated with the background task, such as by executing the pseudocode shown in Table 2 below to invoke the RequestAsync method on the trigger object instantiated and initialized in Table 1 above.

TABLE 2

1 trigger->RequestAsync( );

After act 304, the acts shown in FIG. 3 conclude. In particular, the application foreground process can hereafter be suspended or ended, either under its own control, the user's, or the operating system's, or in response to a crash of the application, the operating system, or the device, and the background task will still proceed to transcode and complete the video sequence specified by the video composition based on repeated indication of the background task in accordance with its trigger.

Those skilled in the art will appreciate that the steps shown in FIG. 3 and in each of the flow diagrams discussed below may be altered in a variety of ways. For example, the order of the steps may be rearranged; some steps may be performed in parallel; shown steps may be omitted, or other steps may be included; a shown step may be divided into substeps, or multiple shown steps may be combined into a single step, etc.

FIG. 4 is a flow diagram showing example acts that may be performed by the facility in some examples to administer the trigger for invocation of the background task. In some examples, the acts of FIG. 4 are performed in the operating system by the background task infrastructure. The facility loops through acts 401-404 until the trigger registered for the video transcoding background task is deactivated. At 402, the facility waits until conditions specified for invocation of the background task are satisfied. As mentioned above, such conditions may include, for example, maximum ambient processing loads, minimum amount of time since the last user interaction, maximum number of background task executing for other applications, etc. At 403, when the background task invocation conditions are satisfied, the facility invokes the background task. At 404, the facility returns to act 401, where the trigger is again tested to see if it has been deactivated. When the trigger is deactivated, such as in step 504 discussed below when the background task is completed, the acts of FIG. 4 conclude.

FIG. 5 is a flow diagram showing example acts that may be performed by the facility in some examples to perform processing-intensive operations in the background task, such as those relating to transcoding and generating a video sequence. At 501, the facility deserializes the composition; that is, it loads the version of the composition saved by the application at 303 in FIG. 3. At 502, the facility performs transcoding and other operations needed to generate the video sequence. For example, in some examples, the facility (1) converts each of the media resources into a common working format; (2) concatenates the media resources in the working format; (3) and converts the concatenated media resources and working format into a destination format. At 503, the facility notifies the application—that is, the application foreground process—that video generation is complete. In some examples, this involves storing an indication of completion in memory shared between the application foregoing process and the background task, such as the memory in which the serialized composition was stored, and/or relaunching the application. In some examples, this involves generating a notification such as a toast informing the user that generation of the video sequence is complete, which the user can then touch, click on, or otherwise activate in order to relaunch the application. At 504, the facility deactivates the trigger. In some examples, act 504 is performed by the application upon its relaunching. After act 504, the acts of FIG. 5 conclude.

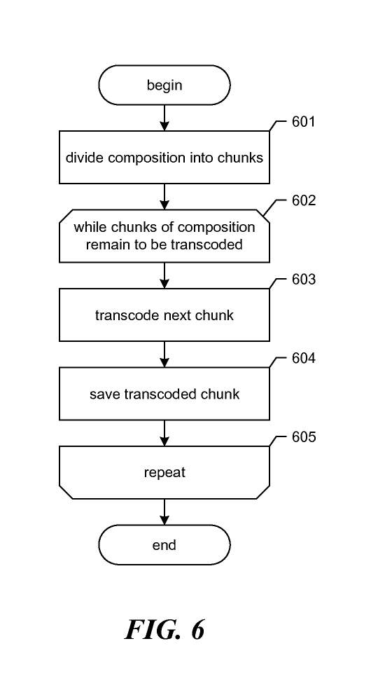

FIG. 6 is a flow diagram showing example acts that may be performed by the facility in some examples to make the operations performed by the background task more interruptible. At 601, the facility divides the composition into chunks, such as chunks each corresponding to a time period for which video transcoding or other video sequence generation operations are to be performed. The facility loops through acts 602-604 while chunks of the composition remain to be transcoded or otherwise processed. At 603, the facility transcodes the next chunk to be transcoded. At 604, the facility saves the chunk transcoded at 603. At 605, if chunks of the composition remain to be transcoded, then the facility continues at 602 to transcode the next chunk, else the acts of FIG. 6 conclude.

FIG. 7 is flow diagram showing steps that may be performed by the facility in some examples to supervise the background task's use of resources. At 701, the facility monitors resource use by the background task. At 702, if resource use exceeds limits established for the background task, then the facility continues in act 703, else the facility continues in act 701. At 703, the facility kills the background task. After the background task is killed, it can be reinvoked in accordance with its trigger, subject to its trigger's invocation conditions. After act 703, the acts of FIG. 7 conclude.

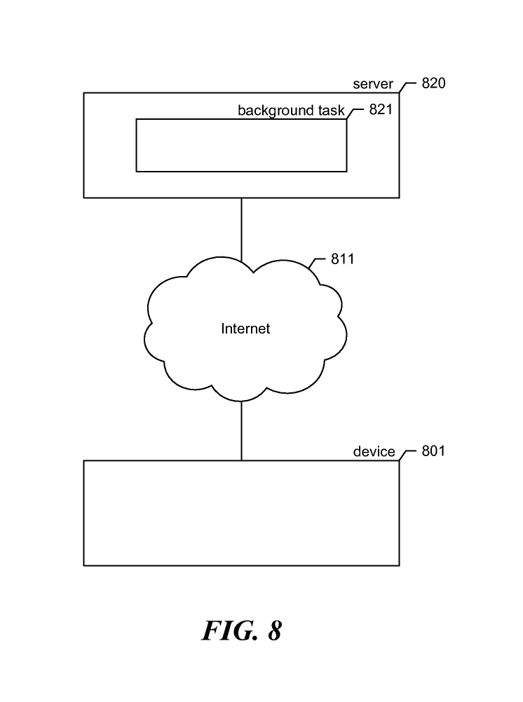

FIG. 8 is a network diagram showing an environment in which the facility may operate in some examples. FIG. 8 illustrates a mode in which the facility offloads the processing of processing-intensive operations to a separate device, such as a cloud server. For example, device 801 connects via the internet to a server 820. Components of the facility executing on the server cause the background task to be executed there, the results returned to the device, and the application to be notified of completion, such as by being relaunched.

In a variety of examples, the facility is adapted to perform a variety of different kinds of processing-intensive operations and other operations. For example, in various examples, the facility performs operations such as selecting the best photos or other media resources among the group; improving the quality of photos, video clips, audio sequences, or media resources of other types; detecting faces in visual media resources; tagging media resources, such as with GPS information identifying the place where they were captured; mixing audio resources; etc.

In some examples, a method in a computing system configured to generate a video sequence is performed. The method comprises: under the control of the video-editing application, registering a background task of the application to generate a video sequence based upon a video composition generated with the video-editing application; in response to the registration of the background task, repeatedly invoking the background task to generate the video sequence; and, when the background task is completed generation of the video sequence, notifying the video-editing application.

In some examples, one or more instances of computer-readable media collectively having contents configured to cause a computing system to perform a method configured to complete a set of operations is provided. The method comprises: under the control of an application, registering a background task to perform the set of operations; and, in response to the registration of the background task, repeatedly invoking the background task to perform a set of operations.

In some examples, one or more instances of computer-readable media correctly having contents comprising a trigger data structure for background tasks is provided. The data structure comprises: a plurality of entries each corresponding to a different background task designated by an application, each entry comprising information usable to automatically invoked the background task to which the entry corresponds, such that the contents the data structure can be used to automatically invoked the background task to which any entry corresponds.

It will be appreciated by those skilled in the art that the above-described facility may be straightforwardly adapted or extended in various ways. While the foregoing description makes reference to particular examples, the scope of the invention is defined solely by the claims that follow and the elements recited therein.

1. A method in a computing system configured to generate a video sequence, the method comprising:
under the control of a video-editing application, registering a background task of the application to generate a video sequence based upon a video composition generated with the video-editing application;
in response to the registration of the background task, repeatedly invoking the background task to generate the video sequence; and
in response to the background task completing generation of the video sequence, notifying the video-editing application.

2. The method of claim 1, further comprising, under the control of the video-editing application, presenting the generated video sequence.

3. The method of 1, further comprising, under the control of the video-editing application, sharing the generated video sequence from a first user to one or more second users.

4. The method of claim 1, further comprising:
in the background task, for each of a plurality of time-contiguous portions of the generated video sequence:
constructing the portion of the generated video sequence; and
persistently storing the constructed portion of the generated video sequence.

5. The method of claim 4 wherein, during construction of a distinguished portion of the generated video sequence, before persistently storing any of the distinguished portion of the generated video sequence, processing of the background task is interrupted,
and wherein, in response to the background task again being invoked after interruption of the processing of the background task, in the background task, the distinguished portion of the generated video sequence is constructed and persistently stored.

6. One or more instances of computer-readable media collectively having contents configured to cause a computing system to perform a method configured to complete a set of operations, the method comprising:
under the control of an application, registering a background task to perform the set of operations; and
in response to the registration of the background task, repeatedly invoking the background task to perform the set of operations.

7. The instances of computer-readable media of claim 6, the method further comprising, in response to the background task completing its performance of the set of operations, notifying the application.

8. The instances of computer-readable media of claim 6, the method further comprising, in response to the background task completing its performance of the set of operations, deregistering the background task.

9. The instances of computer-readable media of claim 6 wherein, as part of registering the background task, the application specifies one or more conditions that must be satisfied for the background task to be invoked.

10. The instances of computer-readable media of claim 6 wherein, in its performance of the set of operations, the background task at least once persistently stores an intermediate result of the set of operations that serves as a basis for resuming the set of operations when execution of the background task is interrupted.

11. The instances of computer-readable media of claim 6, the method further comprising:
recognizing while the background task is executing that it has violated a resource limits established for the background task; and
in response to the recognition, causing execution of the background task to be terminated.

12. The instances of computer-readable media of claim 11, the method further comprising configuring at least one of the resource limits under control of the application.

13. The instances of computer-readable media of claim 6 wherein the application executes on a first computing device, and wherein the background task is invoked on a second computing device distinct from the first computing device.

14. The instances of computer-readable media of claim 13 wherein the first computing device is a smartphone.

15. The instances of computer-readable media of claim 13 wherein the second computing device is a cloud server.

16. The instances of computer-readable media of claim 6, the method further comprising, under the control of the background task, storing a result of the set of operations in memory accessible by the application.

17. The instances of computer-readable media of claim 6, the method further comprising, under the control of the background task, notifying the application that performance of the set of operations has been completed.

18. The instances of computer-readable media of claim 6, the method further comprising, under the control of the background task, in response to completion of the set of operations, causing a user notification to be presented.

19. The instances of computer-readable media of claim 6, the method further comprising, under the control of the background task, in response to completion of the set of operations, causing the application to be launched.

20. The instances of computer-readable media of claim 6 wherein the performance of the set of operations by the background task is with respect to a domain of data that is capable of changing over time.

21. The instances of computer-readable media of claim 6 wherein the application is a video-editing application.

22. The instances of computer-readable media of claim 6 wherein the set of operations performed by the background task comprise format conversion of one or more media assets.

23. The instances of computer-readable media of claim 6 wherein the set of operations performed by the background task comprise tagging resources with automatically-recognized attributes.

24. The instances of computer-readable media of claim 6 wherein the set of operations performed by the background task comprise improving the quality of one or more media assets.

25. One or more instances of computer-readable media collectively having contents comprising a trigger data structure for background tasks, the data structure comprising:
a plurality of entries each corresponding to a different background task designated by an application, each entry comprising information usable to automatically invoke the background task to which the entry corresponds,
such that the contents of the data structure can be used to automatically invoke the background task to which any entry corresponds.

26. The instances of computer-readable media of claim 25, each of at least one of the plurality of entries further comprising information specifying at least one condition that must be satisfied to invoke the background task to which the entry corresponds.

27. The instances of computer-readable media of claim 25, each of at least one of the plurality of entries further comprising information specifying at least one resource limit whose violation by the background task to which the entry corresponds is a basis for terminating execution of the background task to which the entry corresponds.

28. The instances of computer-readable media of claim 25, each of at least one of the plurality of entries further comprising information specifying whether the background task to which the entry corresponds is presently available for invocation.
